(19) United States
(12) Patent Application Publication
(10) Pub. No.: US 2026/0112148 A1
(43) Pub. Date: Apr. 23, 2026

(54) METHOD, DEVICE, NON-TRANSITORY COMPUTER-READABLE STORAGE MEDIUM, AND COMPUTER PROGRAM PRODUCT FOR OBJECT RECOGNITION

(71) Applicant: Hangzhou Ruisheng Software Co., Ltd., Zhejiang (CN)

(72) Inventors: Tao He, Zhejiang (CN); Qingsong Xu, Zhejiang (CN)

(73) Assignee: Hangzhou Ruisheng Software Co., Ltd., Zhejiang (CN)

(21) Appl. No.: 19/312,225

(22) Filed: Aug. 27, 2025

(30) Foreign Application Priority Data
Oct. 22, 2024 (CN) 202411480439.9

(51) Int. Cl. G06V 10/764; G06V 10/25; G06V 10/26; G06V 10/40; G06V 10/82; G06V 10/94; G06V 20/10

(52) U.S. Cl. CPC G06V 10/764; G06V 10/25; G06V 10/267; G06V 10/40; G06V 10/82; G06V 10/945; G06V 20/188

(57) ABSTRACT

Disclosed are a method and a device for object recognition. The method includes: obtaining an object image, wherein the object image includes one or more objects to be recognized; for each object to be recognized, using a pre-trained object recognition model to generate a recognition result of the object to be recognized, and determining a target feature part of the object to be recognized according to the recognition result; and displaying a first screen, wherein the first screen includes at least a part of the object image and target feature information associated with the target feature part.

### CROSS-REFERENCE TO RELATED APPLICATION

This application claims the priority benefit of China application serial no. 202411480439.9, filed on Oct. 22, 2024. The entirety of the above-mentioned patent application is hereby incorporated by reference herein and made a part of this specification.

### BACKGROUND

### Technical Field

The present disclosure relates to object recognition, and specifically relates to a method and device for object recognition.

### Description of Related Art

As technology such as image analysis advances, object recognition has been widely applied in more sectors. In some applications, images or videos may be received from user inputs, and objects to be recognized in the images or videos are identified to obtain recognition results of the objects to be recognized. However, in these applications, there are issues lying in poor user interactivity and poor user experience.

### SUMMARY

A brief overview of the present disclosure is provided below to provide a basic understanding of some aspects of the present disclosure. However, it should be understood that this overview is not an exhaustive overview of the present disclosure. It is not intended to identify key parts or important parts of the present disclosure, nor is it intended to limit the scope of the present disclosure. The purpose of the present disclosure is merely to present some concepts of the present disclosure in a simplified form as a prelude to the more detailed description that is presented later.

One of the purposes of the present disclosure is to provide a method and a device for object recognition.

According to a first aspect of the present disclosure, a method for object recognition is provided, including: obtaining an object image, wherein the object image includes one or more objects to be recognized; for each of the objects to be recognized, using a pre-trained object recognition model to generate a recognition result of the object to be recognized, and determining a target feature part of the object to be recognized according to the recognition result; and displaying a first screen, wherein the first screen includes at least a part of the object image and target feature information associated with the target feature part.

In some embodiments, determining the target feature part of the object to be recognized according to the recognition result includes: determining a candidate feature part corresponding to the recognition result according to the recognition result; and determining, by using a pre-trained part recognition model, the target feature part of the object to be recognized that matches the candidate feature part according to the candidate feature part.

In some embodiments, the target feature information includes: text information describing at least one of size, shape, and color of the target feature part; and/or image information of the target feature part.

In some embodiments, the first screen has one or more first regions, wherein the one or more first regions are determined according to a pre-trained region recognition model and the object image, and a corresponding object to be recognized is displayed in each of the first regions.

In some embodiments, displaying the first screen includes: in response to receiving an operation in the first region, displaying target feature information associated with a target feature part of a corresponding object to be recognized.

In some embodiments, displaying the target feature information associated with the target feature part of the corresponding object to be recognized includes: displaying target feature information associated with a former preset number of target feature parts in order of priority of the target feature parts from high to low.

In some embodiments, displaying the target feature information associated with the target feature part of the corresponding object to be recognized includes: displaying a priority of the target feature part in a form of at least one of text, numbers, and graphics.

In some embodiments, the first screen has a second region, wherein the second region displays information associated with the recognition result of the object to be recognized.

In some embodiments, the recognition result is a species classification to which the object to be recognized belongs, and the information associated with the recognition result of the object to be recognized includes at least one of the following: at least one of a name, an alias, and an image of the species classification to which the object to be recognized belongs; and at least one of a name, an alias, and an image of a genus classification corresponding to the species classification to which the object to be recognized belongs.

In some embodiments, the second region includes at least one of a first interactive object, a second interactive object, and a third interactive object. The method further includes: in response to receiving an operation on the first interactive object, displaying a second screen; in response to receiving an operation on the second interactive object, displaying an answer or a question for the received operation; and in response to receiving an operation on the third interactive object, receiving voice information.

In some embodiments, the second screen includes: at least one of growth characteristics of the object to be recognized, a growth status, pest and disease information, and maintenance guidance for the object to be recognized.

In some embodiments, the first screen has one or more third regions, wherein one of the third regions corresponds to one target feature part, and each of the third regions displays target feature information associated with the corresponding target feature part.

In some embodiments, the method further includes: in response to receiving an operation in the third region, displaying a third screen, wherein the third screen includes additional information associated with the corresponding target feature part.

In some embodiments, the additional information associated with the corresponding target feature part includes at least one of the following: image information of the target feature part, a name of the target feature part, additional image information similar to the image information of the target feature part, a prompt requesting input of one or more additional images about the target feature part, and photographing guidance for the target feature part.

In some embodiments, the third screen includes a fourth interactive object. The method further includes: in response to receiving one or more additional images about the target feature part input based on the fourth interactive object, recognizing the one or more additional images; and updating the target feature information associated with the corresponding target feature part based on a recognition result of the one or more additional images.

According to another aspect of the present disclosure, a device for object recognition is provided, including: a processor; and a memory, wherein instructions are stored in the memory, and when the instructions are executed by the processor, the steps of the method for object recognition as described above are implemented.

According to yet another aspect of the present disclosure, a non-transitory computer-readable storage medium is provided. The non-transitory computer-readable storage medium stores instructions, when the instructions are executed by a processor, the steps of the method for object recognition as described above are implemented.

According to another aspect of the present disclosure, a computer program product is provided, including instructions, and when the instructions are executed by a processor, the steps of the method for object recognition as described above are implemented.

Through the following detailed description of exemplary embodiments of the present disclosure with reference to the accompanying drawings, other features and advantages of the present disclosure will become clearer.

### BRIEF DESCRIPTION OF THE DRAWINGS

The accompanying drawings, which constitute a part of the specification, describe embodiments of the present disclosure and, together with the specification, serve to explain the principles of the present disclosure.

With reference to the accompanying drawings, the present disclosure may be more comprehensible according to the following detailed description, wherein:

FIG. 1 shows a flow chart of a method for object recognition according to an exemplary embodiment of the present disclosure;

FIG. 2 shows a flow chart of determining a target feature part in the method for object recognition according to an exemplary embodiment of the present disclosure;

FIG. 3 to FIG. 5 show schematic views of a first screen according to an exemplary embodiment of the present disclosure;

FIG. 6 shows a structural view of a device for object recognition according to an exemplary embodiment of the present disclosure;

FIG. 7 shows a structural view of a computer system that may implement embodiments of the present disclosure.

Note that, in the implementations described below, the same reference numerals may sometimes be used in common between across drawings to represent the same parts or parts having the same function, and repeated description thereof may be omitted. In this specification, similar reference numerals and characters serve to represent similar items, therefore, once an item is defined in one drawing, it does not need to be further discussed in subsequent drawings.

For ease of understanding, the positions, dimensions, and ranges of various structures shown in the drawings and the like may not represent actual positions, dimensions, and ranges. Therefore, the disclosure is not limited to the positions, dimensions, and ranges disclosed in the drawings and the like. In addition, the drawings are not necessarily drawn to scale, and some features may be enlarged to show details of specific components.

### DESCRIPTION OF THE EMBODIMENTS

Various exemplary embodiments of the present disclosure will be described in detail below with reference to the accompanying drawings. It should be noted that: unless otherwise specifically stated, the relative arrangement of components and steps, numerical expressions and numerical values set forth in these embodiments do not limit the scope of the present disclosure.

The following description of at least one exemplary embodiment is actually merely illustrative and in no way serves as any limitation on the present disclosure and its application or use. That is, the structures and methods herein are shown in an exemplary manner to illustrate different embodiments of the structures and methods in the present disclosure. However, those skilled in the art will understand that they merely illustrate exemplary ways that may be used to implement the present disclosure, rather than exhaustive ways. Furthermore, the drawings are not necessarily drawn to scale, and some features may be enlarged to show details of specific components.

For techniques, methods, and devices known to those of ordinary skill in the relevant art, detailed discussion may not be provided, but where appropriate, the techniques, methods, and devices should be considered as part of the authorized specification.

In all examples shown and discussed herein, any specific values should be interpreted as merely exemplary, and not as limitations. Therefore, other examples of the exemplary embodiments may have different values.

To recognize an object, a user may provide an image including the object to be recognized, and a corresponding object recognition program or a device processes the image for recognition to obtain a recognition result for the object to be recognized. For example, when the object to be recognized is a biological organism, the recognition result obtained may be the biological classification of the object to be recognized, and the unit of the biological classification may be, for example, family, genus, or species, etc.

In some situations, the user may not be satisfied with merely knowing the recognition result of the object to be recognized. Furthermore, when recognizing the species to which a plant object belongs through a large language model based on plant images provided by the user (this process is called species taxonomic process), it is difficult to reflect the professionalism of the recognition result with text descriptions alone, resulting in low user trust in the recognition result. Moreover, after the user provide images, describing the recognition result by displaying a dialogue page is disconnected from the images provided by the user, resulting in poor user interactivity and poor user experience.

To solve the above problems, the present disclosure provides a method and a device for object recognition. By determining a target feature part of an object to be recognized, and displaying at least a part of the image and target feature information associated with the target feature part, it may be possible to interpret a recognition result from at least two aspects, including the image and the target feature information, thereby enhancing user interactivity, improving user experience, and increasing user trust in the recognition result.

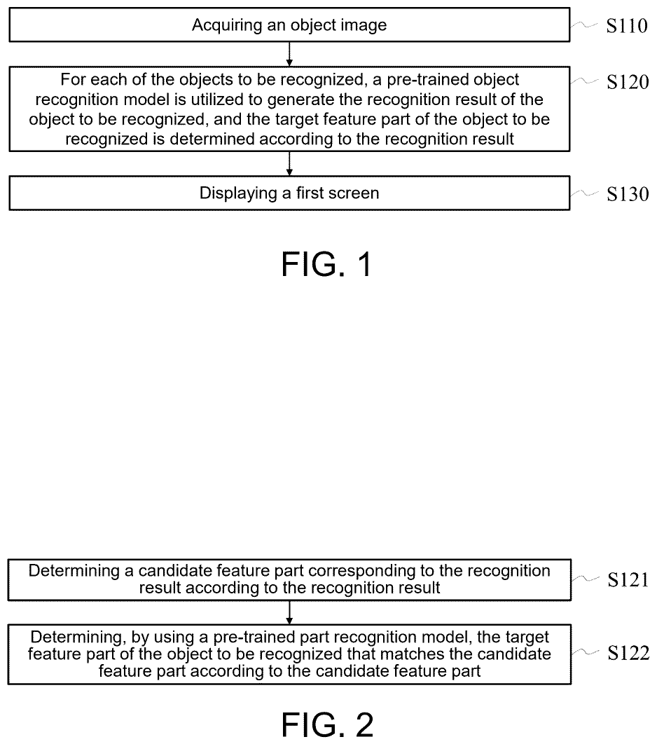

As shown in FIG. 1, in an exemplary embodiment of the present disclosure, a method for object recognition is provided, the method may include:

Step S110. Acquiring an object image.

The object image may include one or more objects to be recognized. In some embodiments described hereinafter, the technical solutions of the present disclosure will be elaborated in detail by taking the object to be recognized as a plant as an example. Those skilled in the art can understand that the object to be recognized may also be other types of objects besides plants, for example, the object to be recognized may also be animals, commemorative coins, etc., which are not limited herein.

In some examples, the object image uploaded by a user may be directly obtained. In other examples, after receiving a user instruction, corresponding prompt information may be generated and output to prompt the user to upload the object image. Further, the prompt information may include a specific requirement for the object image, for example, the prompt information may be a prompt that prompts the user to upload at least one image of an entire plant or upload an image of a specified part of the plant. Alternatively, the prompt information may also include information prompting that the image uploaded by the user has poor clarity and the user needs to re-capture the object to be recognized.

The object image typically includes at least a part of the object to be recognized. For example, when the object to be recognized is a plant, the object image may include any one or a combination of multiple items among the root, stem, leaf, flower, fruit, and seed of the plant to be recognized, where each included item may be the whole or part of this item. The object image may be previously stored by the user, captured in real time, or downloaded from the network. The object image may include visual presentation in any form, such as static images, dynamic images, etc. The object image may be captured using electronic devices including cameras, such as mobile phones, tablet computers, etc.

In some embodiments, the acquired object image may be preprocessed, for example, the image may be denoised, so as to better recognize the object to be recognized in the image subsequently. In another example, the object to be recognized in the object image may be marked. In a specific example, the image may be segmented, generating regions where each of the objects to be recognized is located in the object image, so as to mark the objects to be recognized and recognize each of the objects to be recognized respectively, thus improving the accuracy of recognition.

Continuing to refer to FIG. 1, in an exemplary embodiment of the present disclosure, the method for object recognition may further include:

Step S120. For each of the objects to be recognized, a pre-trained object recognition model is utilized to generate the recognition result of the object to be recognized, and the target feature part of the object to be recognized is determined according to the recognition result.

At least a part of the object image may be input to the pre-trained object recognition model. For example, an entire object image may be input to the pre-trained object recognition model, or a part of the object image containing the object to be recognized may be input to the pre-trained object recognition model. The object recognition model may output one or more classifications of the object to be recognized, which may typically be sorted according to confidence from high to low, and the classification with the highest confidence may be considered as the recognition result of the object to be recognized. In some embodiments, a classification unit of the recognition result generated by using the pre-trained object recognition model may be “species”. Further, the classification with the classification unit of “genus” of the recognition result may be obtained according to the correspondence between “species” and “genus”. In some embodiments, a classification unit of the recognition result generated by using the pre-trained object recognition model may also be “genus” or other classification units with higher hierarchy than “species”. In the present disclosure, the classification with the classification unit of species is referred to as “species classification”, and the classification with the classification unit of genus is referred to as “genus classification”.

In some embodiments, the object recognition model may be trained based on a neural network model, for example, may be trained based on a convolutional neural network model or a deep residual network model. The convolutional neural network model maybe a deep feedforward neural network, which uses a convolutional kernel to scan an object image, extracts a feature to be recognized in the object image, and then recognizes the feature to be recognized of the object to be recognized. Additionally, in the process of recognizing the object image, an original object image may be directly input into the convolutional neural network model without preprocessing the object image. The convolutional neural network model has a higher recognition accuracy and a recognition efficiency compared to other object recognition models. The deep residual network model has an additional identity mapping layer compared to the convolutional neural network model, which may avoid saturation or even decline of accuracy caused by the increase in network depth (the number of stacked layers in the network). An identity mapping function of the identity mapping layer in the deep residual network model needs to satisfy: a sum of the identity mapping function and an input of the deep residual network model equals an output of the deep residual network model. After introducing identity mapping, the deep residual network model is more sensitive to changes in output, therefore the recognition accuracy and recognition efficiency of objects may be significantly improved.

In some embodiments, the specific training process of the object recognition model may be as described below.

A sample set including a preset number of object images marked with a recognition result is prepared. In order to improve a training effect, for each of the possible recognition result, a corresponding number of object images may be prepared, and the number of object images corresponding to each of the recognition results may be the same or different. Object images captured by the user and related information thereof (including capture location, capture time, or capture environment, etc.) may be collected to enrich the samples in the sample set, thus further optimizing the object recognition model based on these collected samples in later stages.

Further, in the sample set, a part of the object images is determined as a test set, and another part of the object images is determined as a training set. The test set and the training set may be manually determined or automatically determined, and the determination process may be random.

Further, the training set serves to train the object recognition model, and the test set serves to test the trained object recognition model, thereby obtaining the accuracy of the object recognition model. The training process specifically includes adjusting various model parameters in the object recognition model. By comparing the accuracy of the object recognition model with a preset accuracy, it may be determined whether training needs to be continued or not. Specifically, when the accuracy of the trained object recognition model is greater than or equal to the preset accuracy, it may be considered that the accuracy of the object recognition model already meets the requirements, and thus training may be ended, and the trained object recognition model may be used to perform object recognition. When the accuracy of the trained object recognition model is less than the preset accuracy, it may be considered that the object recognition model still needs further optimization. Under the circumstances, the object recognition model may be further trained by increasing the number of samples in the training set, specifically by expanding the sample set and/or training set, or by increasing a ratio of the number of samples in the training set to the number of samples in the entire sample set. Alternatively, the object recognition model itself may be adjusted, and the adjusted object recognition model may be trained until the object recognition model meets the requirements.

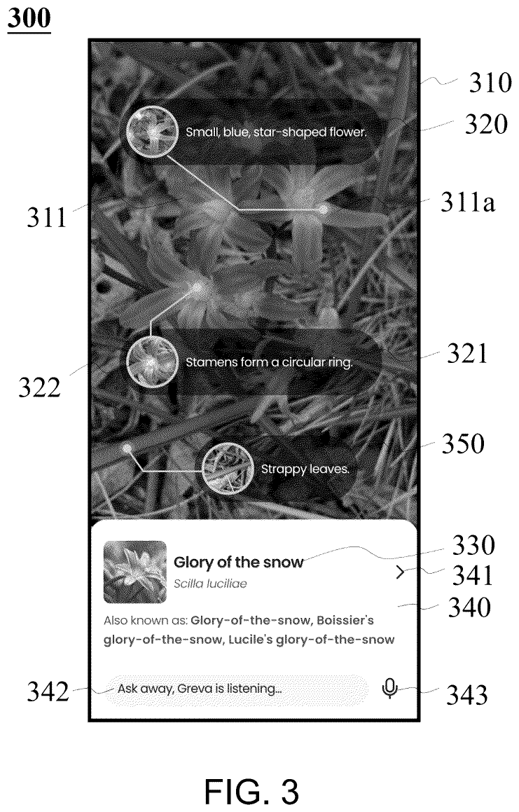

In some embodiments, as shown in FIG. 2, determining the target feature part of the object to be recognized according to the recognition result may include:

Step S121. Determining a candidate feature part corresponding to the recognition result according to the recognition result;

Step S122. Determining, by using a pre-trained part recognition model, the target feature part of the object to be recognized that matches the candidate feature part according to the candidate feature part.

When the recognition result of the object to be recognized is obtained, a corresponding candidate feature part may be determined. In some examples, the candidate feature part corresponding to the recognition result may be obtained by, for example, a processor of the electronic device, from a content management database according to the recognition result. The candidate feature part may be a part in the object to be recognized that has corresponding feature information to reflect the corresponding recognition result. For example, the flowers and leaves of cherry blossom trees typically have morphologies that are distinct from other species. When a plant object is recognized as a cherry blossom tree, it may be determined that the candidate feature parts are flowers and leaves.

Through adopting a pre-trained part recognition model, it is possible to determine whether there is a target feature part that matches the candidate feature part in the object to be recognized. Specifically, an image containing the object to be recognized (for example, an entire object image or an image of a region where the object to be recognized is located in the object image) may be input to the pre-trained part recognition model. In some examples, the image containing the object to be recognized may be recognized according to the candidate feature part to recognize whether there is a corresponding part in the object to be recognized. In a case where a part that matches that candidate feature part is recognized, the recognized part is determined as the target feature part. For example, when determining that candidate feature parts are flowers and leaves, the image containing a corresponding plant object may be recognized according to the pre-trained part recognition model to recognize whether there are flowers and leaves in the image. In a case where flowers and/or leaves are recognized, the flowers and/or leaves are determined as the target feature parts. As such, it is possible to recognize a part of the object to be recognized in a targeted manner according to the candidate feature part and determine the target feature part, thereby reducing influence of interference information such as non-candidate feature parts and external environment on the recognition result, reducing the amount of data that needs to be processed, and improving the recognition efficiency. In other examples, the pre-trained part recognition model may be utilized to recognize a part of the object to be recognized, and determine the part that matches the candidate feature part among the recognized parts of the object to be recognized as the target feature part according to the candidate feature part. For example, it may be recognized that parts of the object to be recognized include fruits, flowers, and leaves according to the pre-trained part recognition model, and if the candidate feature parts are flowers and leaves, then it may be determined that flowers and leaves as the target feature parts. As such, it may be possible to recognize parts contained in the object to be recognized in the image and determine the target feature part that matches the candidate feature part from the recognized parts according to the candidate feature part. In this way, it is possible to update the target feature part in a timely manner according to updates of the candidate feature part.

In some embodiments, the part recognition model may be trained based on a neural network model, for example, may be trained based on a convolutional neural network model or a deep residual network model. The part recognition model may be, for example, a plant part recognition model for recognizing parts of plant objects. In some embodiments, the specific training process of the part recognition model may be derived from the above training process about the object recognition model, which will not be elaborated here. In some embodiments, the part recognition model and corresponding image processing algorithms (such as edge detection algorithms) may be combined for better recognizing parts of objects to be recognized. In some embodiments, the recognition of the objects to be recognized and the recognition of the parts of objects to be recognized may also be implemented by the same pre-trained model, that is, the model may integrate the functions of the above object recognition model and the part recognition model. For example, recognition results of the objects to be recognized and recognition results of the parts of objects to be recognized may be pre-labeled on training samples of the training set so that the trained model may simultaneously recognize the objects to be recognized and the parts of objects to be recognized.

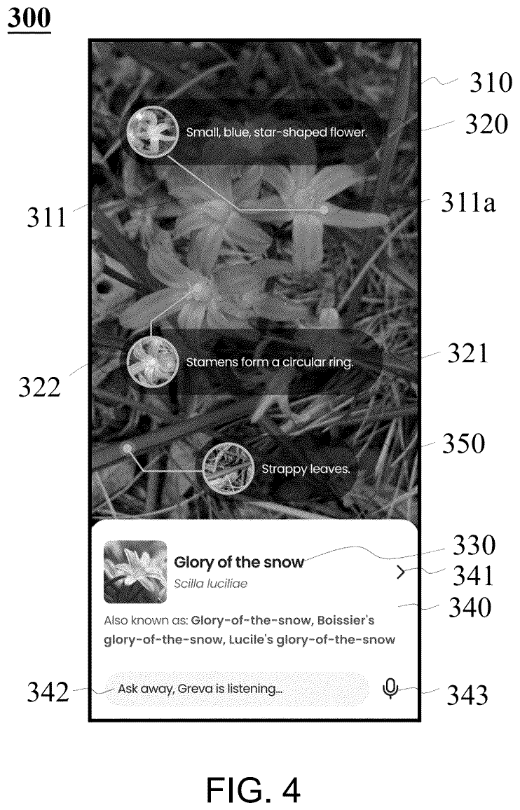

Returning to FIG. 1, referring to FIG. 3 to FIG. 5, in an exemplary embodiment of the present disclosure, the method for object recognition may further include:

Step S130. Displaying a first screen.

The first screen 300 may include at least a part of an object image 310 and target feature information 320 associated with a target feature portion 311a.

A processor of one or more electronic devices may be configured to execute the method for object recognition of the present disclosure, so as to, for example, display the first screen 300 and a second screen and a third screen described below on a user interface (UI) of the one or more electronic devices. The one or more electronic devices may include one or more cameras for capturing static images or recording video streams, and all components for connecting these elements to each other. Each of the one or more electronic devices may include a full-size personal computing device, and may also each be a mobile computing device that wirelessly exchanges data with a server through a network such as the Internet. For example, the one or more electronic devices may be mobile phones, and may also be such as palmtop computers, tablets, wearable devices that may perform wireless communication, or mobile devices capable of obtaining information via the Internet.

In some embodiments, the first screen 300 may include the entire object image 310, and may also include a partial image of the object image 310 that contains one or more objects 311 to be recognized. FIG. 3 to FIG. 5 exemplarily show that the first screen 300 includes the entire object image 310, and the object image 310 has one object 311 to be recognized.

As described above, a target feature part 311a of the object 311 to be recognized may be determined according to the pre-trained part recognition model. In some embodiments, the target feature information 320 associated with the target feature part 311a may also include image information 322 of the target feature part 311a. In some embodiments, the target feature information 320 associated with the target feature part 311a may include text information 321 describing at least one of the size, shape, and color of the target feature part 311a.

As such, it is possible to display to the user the basis for the object to recognize being the corresponding recognition result (for example, the basis for species taxonomic process) in multimodal forms (such as text, images, etc.). Compared to outputting recognition results only in text form, user interactivity may be enhanced, user experience may be improved, and user trust in the recognition results may be increased.

In some embodiments, the first screen 300 may have one or more first regions. The one or more first regions may be determined according to a pre-trained region recognition model and the object image 310. One object 311 to be recognized may correspond to one first region, or in other words, a corresponding object 311 to be recognized may be displayed in each of the first regions.

In some embodiments, one or more object regions of one or more objects 311 to be recognized in the object image 310 may be first determined according to the pre-trained region recognition model and the object image 310, and images of the object regions may be displayed in corresponding first regions of the first screen.

It is worth noting that, in a specific example, a first region may display the corresponding object 311 to be recognized only. In another specific example, a first region may not only display the corresponding object 311 to be recognized, but may also display parts of other objects 311 to be recognized corresponding to adjacent first regions. In other words, any two first regions may partially overlap each other, or may not have overlapping parts.

In some embodiments, the region recognition model may be trained based on a neural network model, for example, may be trained based on a convolutional neural network model or a deep residual network model. The region recognition model may be, for example, a plant region recognition model to recognize the region where a plant object is located in a plant image. In some embodiments, the specific training process of the region recognition model may be derived from the above training process of the object recognition model, which will not be elaborated here. In some embodiments, the recognition of the object to be recognized, the recognition of the parts of the object to be recognized, and the recognition of the region where the object to be recognized is located may also be implemented by the same pre-trained model, that is, the model may integrate the functions of the above object recognition model, the part recognition model and the region recognition model. For example, the recognition result of the object to be recognized, the recognition result of the part of the object to be recognized and the recognition result of the region where the object to be recognized is located may be pre-labeled on training samples of the training set, so that the trained model can simultaneously recognize the object to be recognized, the part of the object to be recognized and the region where the object to be recognized is located.

Through the region recognition model, regions where different objects to be recognized are located may be obtained and displayed in corresponding first regions. Further, the first region may be interactive, so that the user may perform operations in the first region of interest, thereby switching to the current object to be recognized of interest. Then, the first screen may be updated or displayed according to the user's operation, as will be described in detail later. In a specific example, operations in the first regions may include, for example, clicking, pressing, dragging, smearing, etc.

In some embodiments, in response to receiving an operation in the first region, an image of a corresponding object region may be input to the pre-trained object recognition model to generate a recognition result of the corresponding object 311 to be recognized, so as to perform subsequent recognition and screen display in a targeted manner according to the user's operation, thereby saving computational resources and improving the recognition efficiency. In other embodiments, images of each of the object regions may be respectively input to the pre-trained object recognition model to respectively generate the recognition result of each of the objects 311 to be recognized. In this way, when the user switches to the current object to be recognized by performing operations in the first region, the corresponding recognition result may be obtained in a timely manner, so as to facilitate updating or displaying of the first screen subsequently in a timely manner, thereby improving the efficiency of responding to the user's operation.

In some embodiments, displaying the first screen 300 may include: in response to receiving the operation in the first region, displaying the target feature information 320 associated with the target feature part 311a of the corresponding object 311 to be recognized. That is, when the user performs the operation in the first region, the first screen 300 may display the target feature information 320 of the object 311 to be recognized corresponding to the first region where the user's operation is performed. In this way, upon receiving the corresponding operation in the first region, it may be possible to display the target feature information 320 of only the corresponding object 311 to be recognized, so as to switch to the current object 311 to be recognized according to the user's operation and display the corresponding target feature information 320, thus reducing the possibility of visual confusion in the first screen 300 caused by the first screen 300 displaying the target feature information 320 of multiple objects 311 to be recognized, so that the user can obtain the target feature information 320 of each of the objects 311 to be recognized clearly in a timely manner. In other embodiments, displaying the first screen 300 may include displaying the target feature information 320 of each of the objects to be recognized 311 in the object image 310, so that the user can obtain the target feature information 320 of each of the objects 311 to be recognized in a timely manner without performing operations in the first region.

In some embodiments, in response to receiving the operation in the first region, displaying the target feature information 320 associated with the target feature part 311a of the corresponding object 311 to be recognized may include: displaying target feature information associated with a former preset number of the target feature parts 311a (for example, the first 3 target feature parts 311a with the highest priority) according to the priority order of the target feature part 311a from high to low. In the case where the number of the target feature parts 311a is greater than the preset number, the target feature information 320 associated with the former preset number of the target feature parts 311a with the highest priority may be displayed. In the case where the number of the target feature parts 311a is less than or equal to the preset number, the target feature information 320 associated with each of the target feature parts 311a may be displayed. In this way, the target feature information 320 of the former preset number of the target feature parts 311a with the highest priority may be displayed, thereby reducing the possibility of the first screen 300 being cluttered due to displaying too much target feature information 320, and thus preventing the target feature information 320 from occupying too much screen space, as well as improving the display effect of the first screen 300 while displaying the target feature information 320 with a relatively high priority.

In a specific example, taking the recognition result of the object 311 to be recognized as a cherry blossom tree as an example, the flowers of the cherry blossom tree have more obvious features relative to the leaves, so as to be distinguished from other species. Then for the object to be recognized with the recognition result as the cherry blossom tree, the priority of flowers is higher than the priority of leaves. In some embodiments, the priority of the target feature part 311a may be, for example, obtained by a processor of an electronic device according to the recognition result from a content management system prepared in advance.

In some embodiments, the target feature part 311a and/or the target feature information 320 associated with the target feature part 311a may be marked to distinguish different target feature parts 311a and/or the target feature information 320.

In some embodiments, the priority of the target feature part 311a may be displayed in the form of at least one of text, numbers, and graphics, so that the user may know the priority order of the target feature part 311a in a timely manner, for example, the target feature part 311a with a higher priority may be marked with additional graphic symbols “*”.

In some embodiments, as shown in FIG. 3 to FIG. 5, the first screen 300 may include information 330 associated with the recognition result of the object 311 to be recognized, that is, the information 330 associated with the recognition result of the object 311 to be recognized may be displayed on the same screen with the target feature information 320, for example, the species taxonomic result and species taxonomic basis may be displayed simultaneously in the first screen 300. In other embodiments, the information 330 associated with the recognition result of the object 311 to be recognized in the object image 310 may be displayed first before displaying the first screen 300, and then the first screen 300 including the target feature information 320 may be displayed. For example, the species to which the plant in the plant image input by the user belongs may be informed first, and then the first screen 300 containing the target feature information 320 may be displayed, that is, the species taxonomic result may be displayed first and then the species taxonomic basis may be displayed thereafter.

In some embodiments, when the recognition result is the species classification to which the object 311 to be recognized belongs, the information 330 associated with the recognition result of the object 311 to be recognized may include at least one of a name, an alias, and an image of the species classification to which the object 311 to be recognized belongs. In some embodiments, the information 330 associated with the recognition result of the object 311 to be recognized may also include at least one of a name, an alias, and an image of the genus classification corresponding to the species classification to which the object 311 to be recognized belongs.

In some embodiments, as shown in FIG. 3 to FIG. 5, the first screen 300 may have a second region 340, wherein the information 330 associated with the recognition result of the object 311 to be recognized may be displayed in the second region 340. In a specific example, as shown in FIG. 3 to FIG. 5, the second region 340 may be located below the first screen 300, for example, may be located below the target feature information 320.

In some embodiments, the second region 340 may display the information 330 associated with the recognition result of each of the objects 311 to be recognized in the object image 310. In other embodiments, as described above, in response to receiving the operation in the first region, the recognition result of the corresponding object 311 to be recognized may be generated. Correspondingly, the second region 340 may only display the information 330 associated with the recognition result of the current object 311 to be recognized, thus, the user may obtain the information 330 associated with the recognition result of the object 311 to be recognized of interest, thus improving user experience.

As shown in FIG. 3 to FIG. 5, the second region 340 may include a first interactive object 341. In response to receiving an operation on the first interactive object 341, a second screen may be displayed. The first interactive object 341 may be, for example, a button having a preset shape, etc. The operation on the first interactive object 341 may be, for example, clicking, pressing, dragging, smearing, etc. The second screen may include additional information about the object 311 to be recognized, for example, the second screen may include at least one of growth characteristics, a growth status, pest and disease information of the object 311 to be recognized, and maintenance guidance for the object 311 to be recognized. As such, the user may operate the first interactive object 341 to display the second screen including the additional information about the object 311 to be recognized. In some examples, the information 330 associated with the recognition result of the object 311 to be recognized and/or the additional information about the object 311 to be recognized may be, for example, obtained by the processor of the electronic device according to the recognition result of the object 311 to be recognized from the content management system established in advance. In order to facilitate the user to know the object 311 to be recognized at which the additional information about the object 311 to be recognized is targeted in a timely manner, the second screen may also display the recognition result of the object 311 to be recognized and corresponding detailed introduction.

As shown in FIG. 3 to FIG. 5, the second region 340 may include a second interactive object 342. In response to receiving an operation on the second interactive object 342, an answer or a question to the received operation may be displayed. The second interactive object 342 may be, for example, a dialog box. The operation on the second interactive object 342 may be, for example, clicking, pressing, dragging, smearing, etc. In addition, the operation on the second interactive object 342 may also be inputting relevant text information into the second interactive object 342 (exemplify, dialog box). For example, when the user feels that the recognition result and/or certain target feature information does not match with the current object 311 to be recognized, the user may input corresponding questions or supplementary information into the second interactive object 342.

In some embodiments, responses or questions to the received operations may be displayed on an additional screen different from the first screen 300. The responses or questions to the received operations may be generated according to a pre-trained large language model, wherein the large language model may be trained based on a neural network model, for example, may be trained based on a self-attention mechanism-based deep learning model (for example, a transformer model).

As shown in FIG. 3 to FIG. 5, the second region 340 may include a third interactive object 343. In response to receiving an operation on the third interactive object 343, voice information may be received. The third interactive object 343 may be, for example, a button having a preset shape, etc. The operation on the third interactive object 343 may be, for example, clicking, pressing, dragging, smearing, etc. Further, the voice information may be recognized. Subsequently, answers or questions are provided for the received voice information based on the pre-trained large language model. The voice information may also be converted to text information and the converted text information may be input to, for example, the second interactive object 342.

In some embodiments, as shown in FIG. 3 to FIG. 5, the first screen 300 may have one or more third regions 350, wherein one of the third regions 350 may correspond to one target feature part 311a, and each third region may display the target feature information 320 associated with the corresponding target feature part 311a, so as to display the target feature information 320 in a more orderly manner and improve the display effect of the screen. In a specific example, the third region 350 may be located near the corresponding target feature part 311a displayed in the first screen 300.

In a specific example, any two third regions 350 may not have overlapping parts therebetween, or may partially overlap each other, which is not limited here, as long as each of the third regions 350 can clearly display the corresponding target feature information 320. For example, by arranging each of the third regions 350 at a corresponding preset position in the first screen 300, the target feature information 320 displayed by each of the third regions 350 will not blocked by other target feature information 320, allowing the user to clearly know each of the corresponding target feature information 320, and thus improving screen display effects.

In some embodiments, in the first screen 300, at least two of the following elements, including at least a part of the displayed object image 310, the second region 340, and the third region 350, may be configured with different transparency levels so as to enhance the layered visual effect of the screen and improve the display performance. In a specific example, the transparency of at least a part of the displayed object image 310 may be set to lower transparency level compared to the third region 350, so as to better display the target feature information 320 in the third region 350, thereby reducing the possibility that the target feature information 320 is obscured by the object image 310 and displayed unclearly, thus improving user experience.

In some embodiments, in response to receiving an operation in the third region 350, a third screen may be displayed. The third screen may include additional information associated with the corresponding target feature part 311a. That is, the third region 350 may be interactive, and the user may perform operations in the third region 350 of interest to display additional information associated with the corresponding target feature part 311a. In a specific example, the operation in the third region 350 may include clicking, pressing, dragging, smearing, etc..

In some embodiments, the additional information associated with the corresponding target feature part 311a may include at least one of image information of the target feature part 311a, a name of the target feature part, additional image information similar to the image information of the target feature part 311a, a prompt requesting input of one or more additional images about the target feature part 311a, and photographing guidance for the target feature part 311a. The additional information associated with the corresponding target feature part 311a may further include distinguishing features between the target feature part 311a and similar feature parts.

In a specific example, additional information associated with the corresponding target feature part 311a may be, for example, obtained by the processor of the electronic device according to the recognition result of the object 311 to be recognized and/or the corresponding target feature part 311a from the content management system. The content management system may be established in advance, and the content management system may contain multiple sets of names, aliases, and images of similar object categories and/or feature parts that are prone to confusion. The content management system may also include distinguishing features between the similar object categories and/or feature parts, optimized photographing parameters for these distinguishing features, photographing guidance and other information.

In a specific example, integration and extraction of information (for example, results input from the image recognition model and/or information obtained from the content management system) may be performed based on the pre-trained image recognition model (such as the object recognition model and the part recognition model mentioned above) and the large language model to display additional information associated with the corresponding target feature part 311a.

In some embodiments, the third screen may also include a fourth interactive object. The fourth interactive object may be, for example, a button having a preset shape, or may be a dialog box for inputting information. When the user feels that the corresponding target feature information 320 does not match with the current object 311 to be recognized or is interested in the corresponding target feature part 311a, questions may be raised and/or additional information may be provided based on the fourth interactive object. In a specific example, one or more additional images about the target feature part 311a may be input based on the fourth interactive object, for example, additional images may be input through operations such as clicking, pressing, dragging, smearing etc. on the fourth interactive object.

In some embodiments, in response to receiving one or more additional images about the target feature part 311a based on an input from the fourth interactive object, the one or more additional images may be recognized. The pre-trained object recognition model and/or the part recognition model may serve to recognize the additional images. Subsequently, the target feature information 320 associated with the corresponding target feature part 311a may be updated based on recognition results of the one or more additional images to improve accuracy of the displayed target feature information 320. Correspondingly, in some embodiments, the information 330 associated with recognition results corresponding to the recognition results of the one or more additional images may also be updated to improve accuracy of the displayed information 330 associated with the recognition results. In this way, the corresponding displayed screen may be updated based on the recognition results of the one or more additional images, thus enhancing user engagement, strengthening user interactivity, and improving user experience.

In some embodiments, an associated task may be generated and displayed to the user according to content in at least one screen among the first screen, second screen, and third screen. In the case where a device capable of executing the task is connected, the corresponding device may also be automatically and/or manually controlled to execute the task.

In a specific example, a maintenance task and/or a treatment task for the object 311 to be recognized may be generated by, for example, a processor of an electronic device, according to at least one of the recognition result of the object 311 to be recognized, the target feature information 320, the additional information about the object 311 to be recognized and the additional information associated with the target feature part 311a, and output the corresponding maintenance task and/or the treatment task. The maintenance task may, for example, include irrigation, fertilization, light adjustment, pruning, etc. The treatment task may, for example, include pesticide spraying, weeding, soil loosening, etc. The maintenance task and/or the treatment task may further include various parameters of the tasks, such as watering time, intervals, and water volume; fertilizer dosage, timing, and intervals; pruning locations; pesticide spray dosage and application sites, and the like.

Further, it is possible to output identifiers of a maintenance device and/or a treatment device for executing the corresponding maintenance task and/or the treatment task, so that the processor of the electronic device, for example, may control the corresponding maintenance device and/or the treatment device to complete the corresponding maintenance task and/or the treatment task according to the identifier of the maintenance device and/or the treatment device. For example, maintenance devices such as irrigation devices, fertilization devices, light adjustment devices, pruning devices may be controlled to execute maintenance tasks such as irrigation, fertilization, light adjustment, pruning on the object 311 to be recognized. In another example, treatment devices such as pesticide spraying devices, weeding devices, soil loosening devices may be controlled to execute treatment tasks such as pesticide spraying, weeding, soil loosening on the object 311 to be recognized.

The identifier of the maintenance device and/or treatment device may be determined by, for example, the processor of the electronic device according to the maintenance task and/or treatment task from the content management database storing the identifier of the device communicatively coupled with the electronic device.

Since the maintenance device and/or the treatment device typically have communication functions, commands may be transmitted to the maintenance device (for example, via Bluetooth protocol, Zigbee protocol, etc.).

In a specific example, a command to execute the maintenance task and/or the treatment task may be sent to the corresponding maintenance device and/or the treatment device according to the determined identifier of the device for executing tasks, thereby controlling the corresponding device to automatically complete the corresponding maintenance task and/or the treatment task, further reducing the burden on the user and improving maintenance and/or treatment efficiency. Thus, after capturing the object image using the electronic device and uploading the object image, not only may the corresponding screen (first screen, second screen or third screen) be displayed, but also the maintenance task and/or the treatment tasks for the object to be recognized in the object image may be displayed, and the corresponding device may also be automatically controlled to execute the corresponding task, thereby enabling fully automatic monitoring, maintenance and treatment for the object to be recognized.

In another specific example, after displaying the maintenance task and/or the treatment task to the user, the user may be further inquired whether to confirm execution of the corresponding maintenance and/or treatment, and after the user confirms execution of the corresponding maintenance and/or treatment, the corresponding device is controlled to execute the corresponding task according to the maintenance task and/or the treatment task.

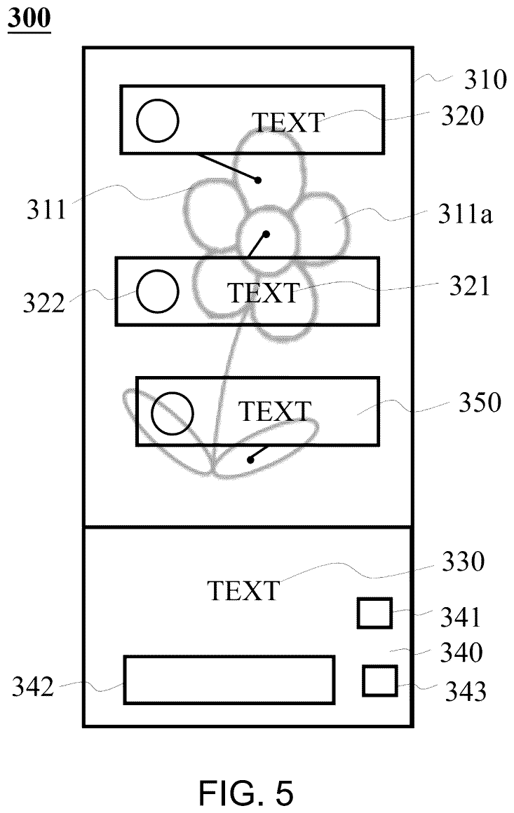

According to another aspect of the present disclosure, a device for object recognition is also provided. As shown in FIG. 6, a device 400 for object recognition may include a processor 410 and a memory 420. Instructions are stored in the memory 420, and the instructions, when executed by the processor 410, implement the steps of the method for object recognition described in any of the aforementioned embodiments of the present disclosure.

The processor 410 may be an integrated circuit chip having a signal processing capability. The processor may be a general-purpose processor, a digital signal processor (DSP), an application-specific integrated circuit (ASIC), a field-programmable gate array (FPGA), or other programmable logic devices, discrete gates or transistor logic devices, discrete hardware components, for implementing or executing various methods, steps, and logic block diagrams disclosed in the examples of the present disclosure. The general-purpose processor may be a microprocessor, or the processor may also be any conventional processor, etc., and may be an X86 architecture or an ARM architecture, etc.

The memory 420 may be a volatile memory or a non-volatile memory, or may include both the volatile memory and the non-volatile memory. The non-volatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM), which serves as external cache. By way of exemplary but not restrictive illustration, many forms of RAM are available, such as a static random access memory (SRAM), a dynamic random access memory (DRAM), a synchronous dynamic random access memory (SDRAM), a double data rate synchronous dynamic random access memory (DDRSDRAM), an enhanced synchronous dynamic random access memory (ESDRAM), a synchlink dynamic random access memory (SLDRAM), and a direct rambus random access memory (DRRAM). It should be noted that the memory described herein is intended to include but not limited to these memories and any other suitable types of memory.

According to another aspect of the present disclosure, a non-transitory computer readable storage medium is also provided. The non-transitory computer readable storage medium stores instructions, when the instructions are executed, the steps of the method for object recognition described in any of the foregoing embodiments of the present disclosure may be implemented.

Similarly, the non-transitory computer-readable storage medium in the embodiments of the present disclosure may be the volatile memory or the non-volatile memory, or may include both the volatile memory and the non-volatile memory. It should be noted that the non-transitory computer-readable storage medium described herein is intended to include but not limited to these memories and any other suitable types of memory.

According to another aspect of the present disclosure, a computer program product is also provided. The computer program product includes a computer program, when the computer program is executed by a processor, the computer program implement the steps of the method for object recognition described in any of the foregoing embodiments of the present disclosure.

The instructions may be any instruction set to be executed directly by one or more processors, such as machine codes, or any instruction set to be executed indirectly, such as scripts. The terms “instructions”, “applications”, “processes”, “steps” and “programs” (including “computer programs”) may be used interchangeably herein. The instructions may be stored in an object code format for direct processing by one or more processors, or stored as any other computer language, including scripts or collections of independent source code modules that are interpreted on demand or compiled in advance. The instructions may include instructions that make one or more processors to serve as various neural networks herein. Other parts herein explain the functions, methods and routines of the instructions in further details.

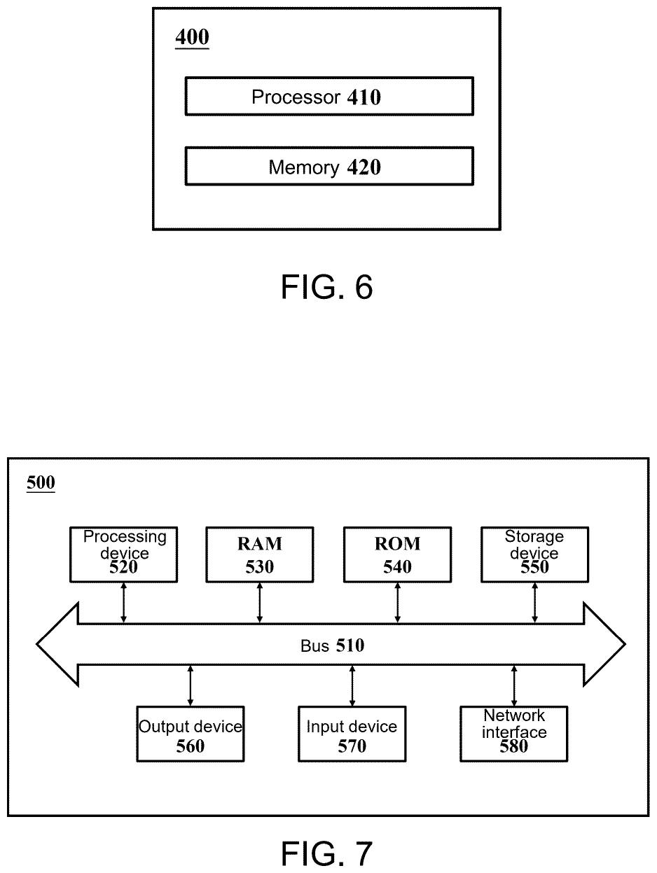

FIG. 7 shows a schematic block diagram of a computer system 500 on which the embodiments of the present disclosure may be implemented. The computer system 500 includes a bus 510 or other communication mechanisms for transmitting information, and a processing device 520 coupled with the bus 510 for processing information. The computer system 500 also includes a memory 530 coupled with the bus 510 for storing instructions to be executed by the processing device 520. The memory 530 may be a random access memory (RAM) or other dynamic storage devices. The memory 530 may also be used for storing temporary variables or other intermediate information during execution of instructions to be executed by the processing device 520. The computer system 500 may also include a read-only memory (ROM) 540 or other static storage devices coupled to the bus 510 for storing static information and instructions for the processing device 520. A storage device 550 such as a magnetic disk or an optical disk is provided and coupled to the bus 510 for storing information and instructions. The computer system 500 may be coupled to an output device 560 through the bus 510 for providing an output to the user, such as but not limited to a display (such as a cathode ray tube (CRT) or liquid crystal display (LCD)), a speaker, etc. An input device 570 such as keyboards, mice, microphones, etc. are coupled to the bus 510 for transmitting information and command selections to the processing device 520. The computer system 500 may execute the embodiments of the present disclosure. Consistent with some implementations of the present disclosure, results are provided by the computer system 500 in response to the processing device 520 executing one or more sequences of one or more instructions contained in the memory 530. Such instructions may be read into the memory 530 from another computer-readable medium such as the storage device 550. Execution of the instruction sequences contained in the memory 530 causes the processing device 520 to execute the methods described herein. Alternatively, hard-wired circuitry may be used in place of or in combination with software instructions to implement the present teachings. Thus, implementations of the present disclosure are not limited to any specific combination of hardware circuitry and software. In various embodiments, the computer system 500 may be connected to one or more other computer systems like the computer system 500 across a network via a network interface 580 to form a networked system. The network may include a private network or a public network such as the Internet. In a networked system, one or more computer systems may store data and supply the data to other computer systems. As used herein, the term “computer-readable medium” refers to any medium that participates in providing instructions to the processing device 520 for execution. Such medium may take many forms, including but not limited to non-volatile media, volatile media, and transmission media. The non-volatile media include, for example, optical or magnetic disks such as the storage device 550. The volatile media include a dynamic memory such as the memory 530. The transmission media include coaxial cables, copper wires, and optical fibers, including the wiring that includes the bus 510. Common forms of the computer-readable media or the computer program products include, for example, floppy disks, flexible disks, hard disks, magnetic tape, or any other magnetic medium, CD-ROM, digital video disk (DVD), Blu-ray disk, any other optical medium, thumb drives, memory cards, RAM, PROM and EPROM, flash EPROM, any other memory chip or cartridge, or any other tangible medium from which a computer may read data. Various forms of computer-readable media may be involved in carrying the one or more sequences of the one or more instructions to the processing device 520 for execution. For example, the instructions may initially be carried on a magnetic disk of a remote computer. The remote computer may load the instructions into a dynamic memory thereof and send the instructions over a telephone line using a modem. A modem local to the computer system 500 may receive the data on the telephone line and use an infrared transmitter to convert the data into an infrared signal. An infrared detector coupled to the bus 510 may receive the data carried in the infrared signal and place the data on the bus 510. The bus 510 carries the data to the memory 530, from which the processing device 520 retrieves and executes the instructions. Optionally, the instructions received by the memory 530 may be stored in the storage device 550 before or after being executed by the processing device 520.

According to various embodiments, instructions configured to be executed by the processing device 520 to execute the method are stored in the computer-readable medium. The computer-readable medium may be a device that stores digital information. For example, the computer-readable medium includes compact disk read-only memory (CD-ROM) as known in the art for storing software. The computer-readable medium is accessed by a processor suitable for executing instructions configured to be executed.

In the technical solution of the present disclosure, by determining the target feature part of the object to be recognized, displaying at least a part of the object image and the target feature information associated with the target feature part, it is possible to interpret the recognition result from multiple aspects, so that the user interactivity is enhanced. This approach functions as if a professional were providing explanations while examining the object to be recognized, not only delivering an immersive experience but also demonstrating the professionalism of object recognition, thus improving user acceptance and confidence in the recognition results and enhancing user experience. Furthermore, the present disclosure may present the basis for recognizing the object to be recognized as the corresponding recognition result in a multimodal manner (for example, the species taxonomic basis for plant objects), so as to further enhance user interactivity and improve user experience. According to some embodiments of the present disclosure, in conjunction with a content management system, similar visual examples of corresponding parts may be displayed to users to further establish user confidence.

The terms “left,” “right,” “front,” “rear,” “top,” “bottom,” “upper,” “lower,” “high,” “low,” and the like in the specification and claims, if present, are used for descriptive purposes and are not necessarily used to describe invariant relative positions. It should be understood that such terms are interchangeable under appropriate circumstances, so that the embodiments of the present disclosure described herein may, for example, operate in other orientations different from those shown or otherwise described herein. For example, when a device in the drawings is inverted, features previously described as being “above” other features may then be described as being “below” other features. The device may also be oriented in other ways (rotated 90 degrees or in other orientations), and the relative spatial relationships will be interpreted accordingly.

In the specification and claims, when an element is referred to as being “on” another element, “attached” to another element, “connected” to another element, “coupled” to another element, or “contacting” another element, etc., the element may be directly on the other element, directly attached to the other element, directly connected to the other element, directly coupled to the other element, or directly contacting the other element, or one or more intermediate elements may be present. In contrast, when an element is referred to as being “directly” on another element, “directly attached” to another element, “directly connected” to another element, “directly coupled” to another element, or “directly contacting” another element, no intermediate elements will be present. In the specification and claims, when a feature is arranged to be “adjacent” to another feature, it may refer to one feature having a part that overlaps with the adjacent feature or a part that is located above or below the adjacent feature.

As used herein, the term “exemplary” means “serving as an example, instance, or illustration” and not as a “model” to be precisely copied. Any implementation described herein as exemplary is not necessarily to be construed as preferred or advantageous over other implementations. Moreover, the present disclosure is not limited by any expressed or implied theory presented in the technical field, background art, summary of the disclosure, or detailed description of the embodiments.

As used herein, the term “substantially” means including any minor variations caused by defects in design or manufacturing, tolerances of devices or components, environmental influences and/or other factors. The term “substantially” also allows for differences from perfect or ideal situations caused by parasitic effects, noise, and other practical considerations that may exist in actual implementations.

Additionally, terms such as “first,” “second,” and the like may also be used herein for the purpose of reference only, and thus are not intended to be limiting. For example, the terms “first,” “second,” and other such numerical terms referring to structures or components do not imply a sequence or order unless the context clearly indicates otherwise.

It should also be understood that the term “including/comprising” when used herein indicates the presence of the stated features, integers, steps, operations, elements and/or components, but does not preclude the presence or addition of one or more other features, integers, steps, operations, elements and/or components and/or combinations thereof.

In the present disclosure, the term “provide” is used broadly to cover all methods of obtaining an object, thus “providing an object” includes but is not limited to “purchasing”, “preparing/manufacturing”, “arranging/setting”, “installing/assembling”, and/or “ordering” the object, etc.

As used herein, the term “and/or” includes any and all combinations of one or more of the associated listed items. The terminology used herein is for the purpose of describing particular embodiments only and is not intended to be limiting of the present disclosure. As used herein, the singular forms “a,” “an,” and “the” are intended to include the plural forms as well, unless the context clearly indicates otherwise.

Those skilled in the art should realize that the boundaries between the above operations are merely illustrative. Multiple operations may be combined into a single operation, a single operation may be distributed among additional operations, and operations may be executed at least partially overlapping in time. Moreover, alternative embodiments may include multiple instances of specific operations, and the order of operations may be changed in other various embodiments. However, other modifications, variations and substitutions are equally possible. Aspects and components of all embodiments disclosed above may be combined in any way and/or with aspects or components of other embodiments to provide multiple additional embodiments. Therefore, this specification and the drawings should be regarded as illustrative rather than restrictive.

Although some specific embodiments of the present disclosure have been described in detail through examples, those skilled in the art should understand that the above examples are for illustration only and are not intended to limit the scope of the present disclosure. The embodiments disclosed herein may be combined in any manner without departing from the spirit and scope of the present disclosure. Those skilled in the art should also understand that various modifications may be made to the embodiments without departing from the scope and spirit of the present disclosure. The scope of the present disclosure is defined by the appended claims.

What is claimed is:

1. A method for object recognition, the method comprising:
obtaining an object image, wherein the object image comprises one or more objects to be recognized;
for each of the objects to be recognized, using a pre-trained object recognition model to generate a recognition result of the object to be recognized, and determining a target feature part of the object to be recognized according to the recognition result; and
displaying a first screen, wherein the first screen comprises at least a part of the object image and target feature information associated with the target feature part.

2. The method according to claim 1, wherein the step of determining the target feature part of the object to be recognized according to the recognition result comprises:
determining a candidate feature part corresponding to the recognition result according to the recognition result; and
determining, by using a pre-trained part recognition model, the target feature part of the object to be recognized that matches the candidate feature part according to the candidate feature part.

3. The method according to claim 1, wherein the target feature information comprises:
text information describing at least one of size, shape, and color of the target feature part; and/or;
image information of the target feature part.

4. The method according to claim 1, wherein the first screen has one or more first regions, wherein the one or more first regions are determined according to a pre-trained region recognition model and the object image, and a corresponding object to be recognized is displayed in each of the first regions.

5. The method according to claim 4, wherein the step of displaying the first screen comprises:
in response to receiving an operation in the first region, displaying target feature information associated with a target feature part of the corresponding object to be recognized.

6. The method according to claim 5, wherein the step of displaying the target feature information associated with the target feature part of the corresponding object to be recognized comprises:
displaying target feature information associated with a former preset number of target feature parts in order of priority of the target feature parts from high to low.

7. The method according to claim 5, wherein the step of displaying the target feature information associated with the target feature part of the corresponding object to be recognized comprises:
displaying a priority of the target feature part in a form of at least one of text, numbers, and graphics.

8. The method according to claim 1, wherein the first screen has a second region, wherein the second region displays information associated with the recognition result of the object to be recognized.

9. The method according to claim 8, wherein the recognition result is a species classification to which the object to be recognized belongs, and the information associated with the recognition result of the object to be recognized comprises at least one of the following:
at least one of a name, an alias, and an image of the species classification to which the object to be recognized belongs; and
at least one of a name, an alias, and an image of a genus classification corresponding to the species classification to which the object to be recognized belongs.

10. The method according to claim 8, wherein the second region comprises at least one of a first interactive object, a second interactive object, and a third interactive object, the method further comprising:
in response to receiving an operation on the first interactive object, displaying a second screen;
in response to receiving an operation on the second interactive object, displaying an answer or a question for the received operation; and
in response to receiving an operation on the third interactive object, receiving voice information.

11. The method according to claim 10, wherein the second screen comprises: at least one of growth characteristics of the object to be recognized, a growth status, pest and disease information, and maintenance guidance for the object to be recognized.

12. The method according to claim 1, wherein the first screen has one or more third regions, wherein one of the third regions corresponds to one of the target feature parts, and each of the third regions displays the target feature information associated with the corresponding target feature part.

13. The method according to claim 12, wherein the method further comprises:
in response to receiving an operation in the third region, displaying a third screen, wherein the third screen comprises additional information associated with the corresponding target feature part.

14. The method according to claim 13, wherein the additional information associated with the corresponding target feature part comprises at least one of the following:
image information of the target feature part, a name of the target feature part, additional image information similar to the image information of the target feature part, a prompt requesting input of one or more additional images about the target feature part, and photographing guidance for the target feature part.

15. The method according to claim 13, wherein the third screen comprises a fourth interactive object, the method further comprising:
in response to receiving one or more additional images about the target feature part input based on the fourth interactive object, recognizing the one or more additional images; and
updating the target feature information associated with the corresponding target feature part based on a recognition result of the one or more additional images.

16. A device for object recognition, the device comprising a processor; and a memory, wherein instructions are stored in the memory, and when the instructions are executed by the processor, the steps of the method according to claim 1 is implemented.

17. A non-transitory computer-readable storage medium, wherein the non-transitory computer-readable storage medium stores instructions, when the instructions are executed by a processor, the steps of the method according to claim 1 is implemented.

18. A computer program product, comprising instructions, and when the instructions are executed by a processor, the steps of the method according claim 1 is implemented.

19. A device for object recognition, the device comprising a processor; and a memory, wherein instructions are stored in the memory, and when the instructions are executed by the processor, the steps of the method according to claim 2 is implemented.

20. A device for object recognition, the device comprising a processor; and a memory, wherein instructions are stored in the memory, and when the instructions are executed by the processor, the steps of the method according to claim 3 is implemented.
